(19) United States
(12) Patent Application Publication
(10) Pub. No.: US 2013/0105488 A1
(43) Pub. Date: May 2, 2013

(54) STEP GARBAGE CAN WITH DAMPER

(71) Applicant: David Quan, Toronto (CA)

(72) Inventor: David Quan, Toronto (CA)

(73) Assignee: UMBRA LLC, Buffalo, NY (US)

(21) Appl. No.: 13/408,546

(22) Filed: Feb. 29, 2012

Related U.S. Application Data
(63) Continuation-in-part of application No. 29/404,914, filed on Oct. 26, 2011, now Pat. No. D673750.

(51) Int. Cl. B65F 1/06; B65D 43/26; B65F 1/16

(52) U.S. Cl. 220/495.08; 220/263

(57) ABSTRACT

The present invention broadly comprises a garbage can including a can portion with an open top and a lid with a bag ring pivotally attached to the lid and arranged to pivot onto and off the upper rim. Also included is a pedal assembly attached to a riser that moves the lid off the container when the pedal is depressed. A damper is fixedly attached to the outer surface of the container bottom wall and operatively attached to the riser. In a preferred embodiment, when the pedal is released, the damper prevents the riser from falling freely thereby causing the lid to close slowly.

### CROSS REFERENCE TO RELATED APPLICATIONS

This application is filed under 35 U.S.C. §120 as a continuation-in-part patent application of U.S. Design Patent Application No. 29/404,914, filed Oct. 26, 2011, which application is incorporated herein by reference in its entirety.

### FIELD OF THE INVENTION

The present invention relates broadly to garbage cans, more specifically to garbage cans with a closable lid and bag ring, and still more specifically to garbage cans with a controlled closing speed.

### BACKGROUND OF THE INVENTION

Garbage containers are well known in the prior art. Garbage containers often include lids that may be opened without manually lifting the lid off the container. Often such containers use a pedal system in which a foot pedal is depressed to open the lid. In these containers, the lids are often attached with a hinge or other pivotal attachment which is connected directly or indirectly to a lifter that directly activates the lid. When the pedal is released, the lid freely falls back to close the garbage can.

One problem with current garbage cans occurs if the lid falls too quickly. This often happens if the user's foot slips off the pedal before the user is finished depositing garbage or trash into the container. In this case, the lid may prematurely fall on the user's hand or arms spilling trash and resulting in inconvenience, injury to the user and possible infection contracted from the garbage dropped onto the user or surrounding environment.

Thus, there is a need in the field for a garbage container having a system that produces a slow, controlled, and reliable closure of the container lid.

### SUMMARY OF THE INVENTION

The present invention broadly comprises a garbage can including a can portion having a bottom wall, at least one tubular wall extending upwardly from the bottom wall and including an upper rim, an inner chamber defined by the bottom wall and the tubular wall, and an open top; a lid; a bag ring having a recessed under surface adapted to receive the upper rim therein, the ring being pivotally coupled to the lid and arranged to pivot onto and off of the upper rim; a pedal assembly, the pedal assembly including a pedal lever operatively attached to said bottom wall and having a first end and a second end, said first end including a pedal; a riser having a first end and a movement end, wherein the movement end of the riser is pivotably connected to the second end of said pedal lever and the first riser end is pivotably connected to the lid; and, a damper fixedly attached to said outer surface of said bottom wall and operatively attached to said riser. The pedal lever is arranged to lever the riser upwardly when said step pedal is depressed, and the riser is arranged to pivot the lid off of the ring when levered upwardly by the step pedal. In a preferred embodiment, when the pedal is released, the damper prevents the riser from falling freely thereby causing the lid to close slowly.

One object of the invention is to provide a garbage can that caused the lid to close slowly.

A second object of the invention is to supply a garbage can in which the container is water tight or integral in construction.

A third object of the invention is to present a garbage can in which the pedal assembly is outside the garbage storage chamber.

An additional object is to provide a ring-lid assembly in which the bag ring pivots independently on the lid.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 is a front view of the garbage can of the present invention;

FIG. 2 is a rear view of the garbage can of the present invention;

FIG. 3 is a top view of the garbage can with the lid removed looking into the open container;

FIG. 4 is a top perspective view showing the bag ring pivotably connected to the lid;

FIG. 5 is a close up view of the rotatable attachments of the lid and the bag ring;

FIG. 6 is a bottom view of the garbage can of the present invention;

FIG. 7 is an enlarged view of the connection between the riser and the movement end of the pedal lever;

FIG. 8 is an enlarged view of the pedal assembly;

FIG. 9 is an enlarged bottom view of the garbage can showing the damper fixedly attached to the well located at the back end of center portion of the bottom surface;

FIG. 9A shows the riser attached to the piston component of the damper;

FIG. 10 is a perspective view of the piston;

FIGS. 11 and 11A are schematic figures demonstrating the action of the damper on the riser; and,

FIG. 12 is a schematic demonstration as to how the damper slows the fall of piston and attached riser.

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. Although any methods, devices or materials similar or equivalent to those described herein can be used in the practice or testing of the invention, the preferred methods, devices, and materials are now described. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

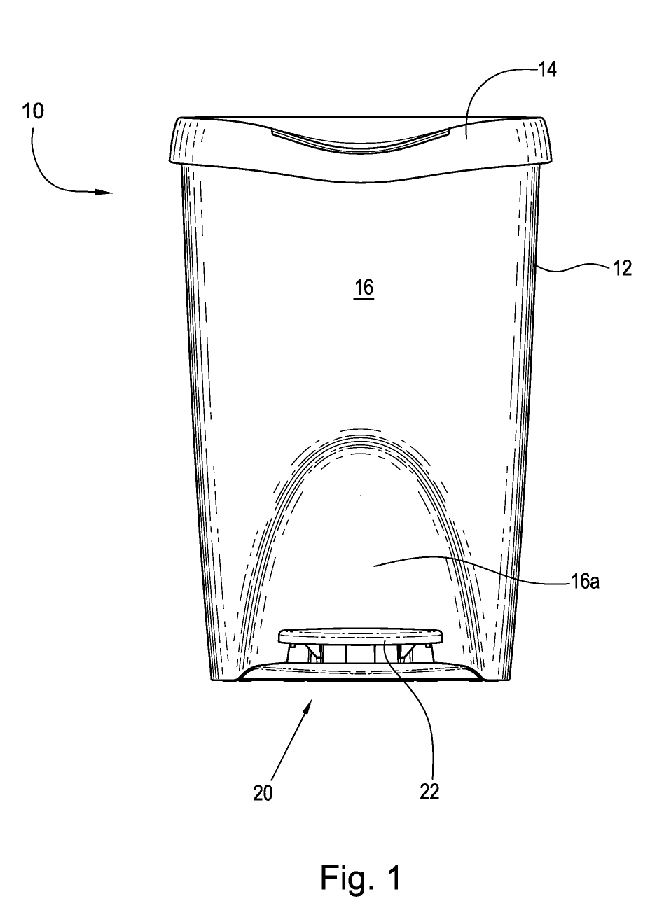

Adverting to the drawings, FIG. 1 is a front view of garbage can 10 (“can 10”). Container 12 is seen with lid 14 covering the open, upper rim of container 12. Container 12 includes tubular wall 16, which includes depression 16a, and bottom wall 17 which together define a chamber. Pedal assembly 20 fits into depression 16a with pedal 22 located at the first end of pedal assembly 20. Pedal assembly 20 is attached to bottom wall 17 (not seen in FIG. 1). Pedal 22 is used to open lid 14 as discussed below.

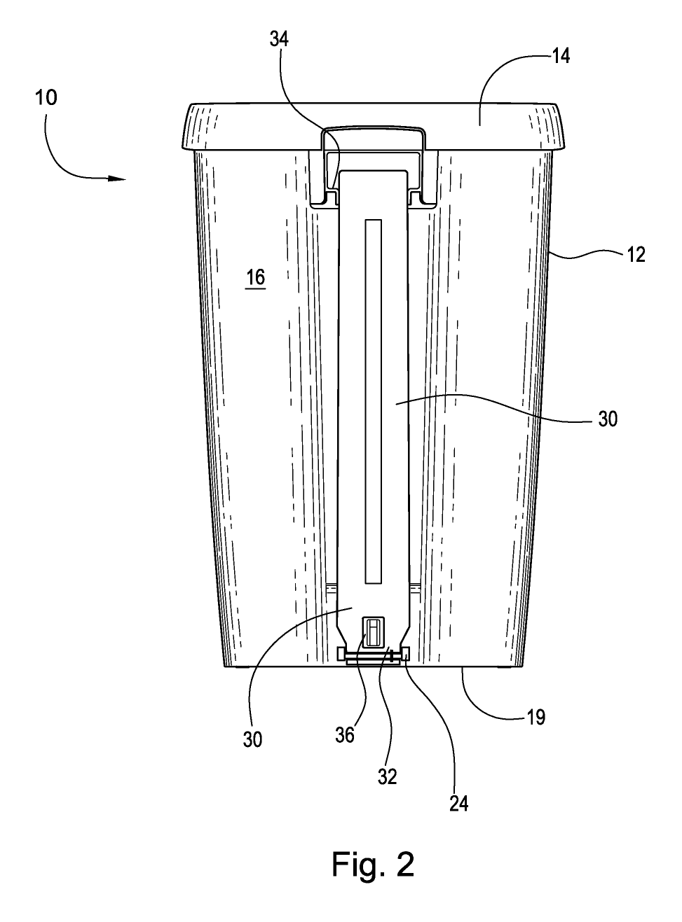

FIG. 2 is a rear view of can 10 with riser 30 extending along the outer surface of tubular wall 16. Riser 30 is positioned on the opposite side of pedal 22. First end 32 of riser 30 is movably attached to second or movement end 24 of pedal lever 23 (not seen in FIG. 2) and pivotally attached to lid 14. By movably attached is meant that while riser 30 and pedal lever 23 are fastened together, riser 30 and pedal lever 23 may independently rotate around and/or slide laterally at the connection point.

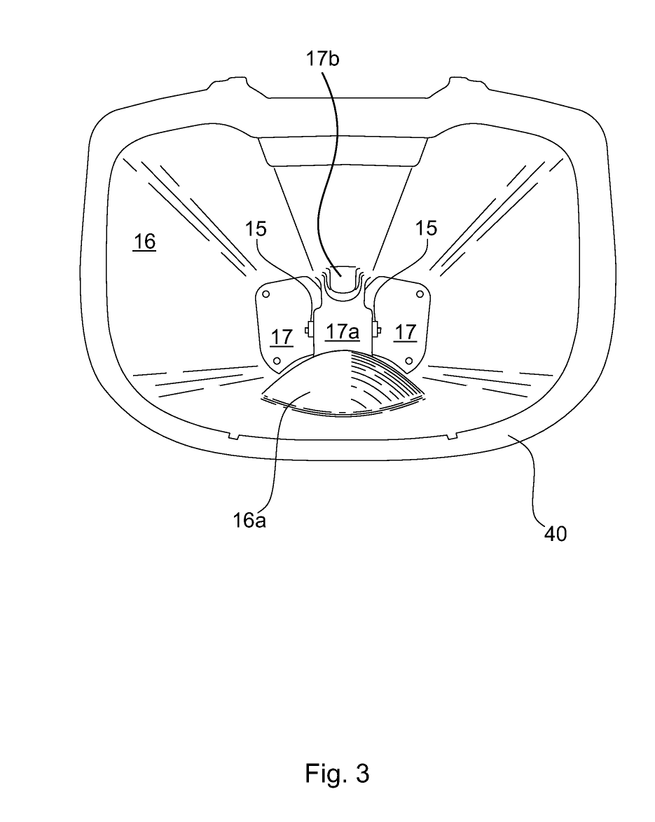

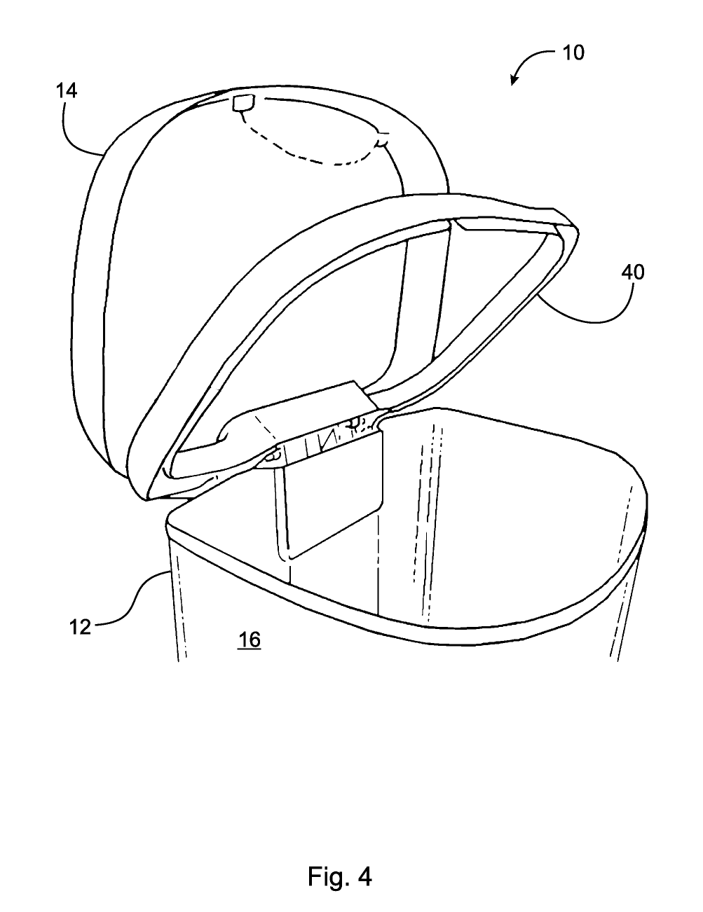

FIG. 3 is a top view of can 10 with lid 14 removed looking into open container 12. Tubular wall 16 extends from bottom wall 17. Persons of skill in the art will recognize that there may be a plurality of tubular walls 16 extending from bottom wall 17 such as is rectangular or other polygonal shaped cans 10. Center portion 17a of bottom wall 17 is raised to accommodate pedal assembly 20 which is discussed below. Receivers 15, formed in center portion 17a, receive slots 25a of pedal assembly 20 to form an operative attachment of pedal assembly 20 to container 12. By operatively attached is meant that a component or device is connected either directly or indirectly to a second component and causes one of those components to function. For example, as described above, pedal lever 23 is described as operatively attached or operationally attached to the slots 15 meaning the attachment is such as to allow pedal lever 23 to operate to move riser 30 up and down as described below. FIG. 3 also shows bag ring 40 resting on the upper rim of container 12.

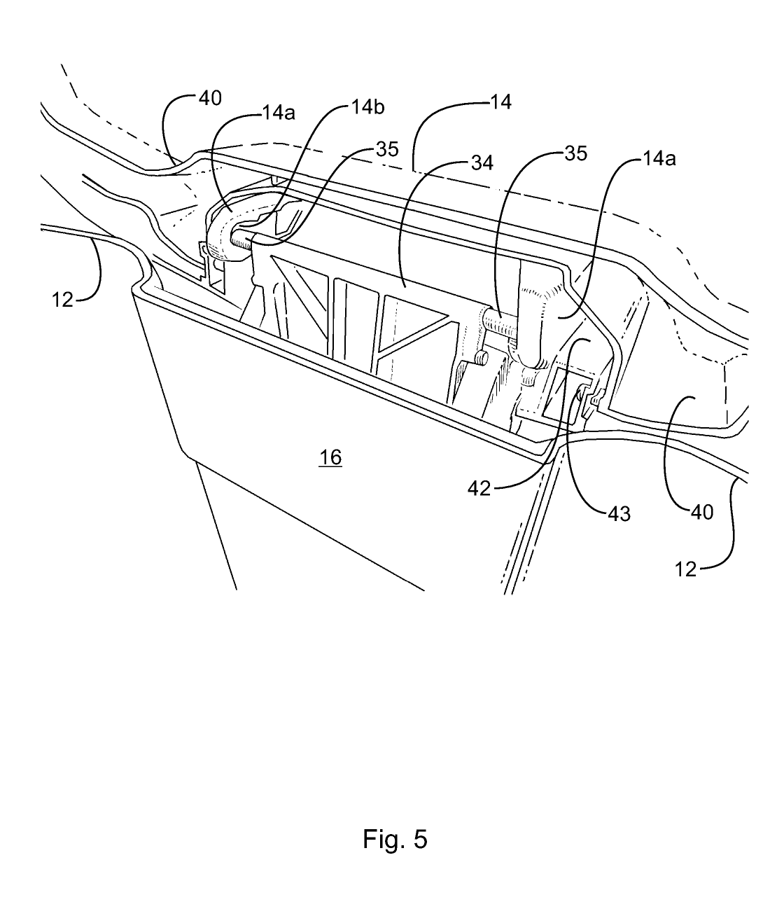

FIG. 4 is a top perspective view showing bag ring 40 pivotably connected to lid 14 and having recessed under-surface adapted to receive the upper rim of container 12. FIG. 4 demonstrates that lid 14 and bag ring 40 have separate and independent pivotal attachments, with ring 40 pivotally connected to lid 14 and lid 14 pivotally connected to first riser end 34. FIG. 5 depicts the pivotal attachments of lid 14 to first riser end 34. Lid 14 includes opposing ears 14a which include ear slots 14b. Riser pin 35 (“pin 35”) extends to either side of lid end 34 into slot 14b. When riser 30 is elevated by pedal lever 23, it rotates ears 14a upward which thereupon rotates lid 14 upward. Conversely, when riser 30 falls, it will pull down on ears 14a to pull lid 14 to the upper rim of container 12.

FIG. 5 also illustrates the pivotal attachment of ring 40 to lid 14. Opposing pins 43 extend into channels 42 and provide a rotating or pivoting connection with lid 14. It can be seen that when lid 14 is rotated up, ring 40 is separately rotatable around pins 42. This lid-bag ring assembly provides the advantage of having no attachment to the container allowing both container and lid-bag ring assembly to be shipped in smaller, cheaper shipping cartons in which multiple units of each type may be stacked or nested.

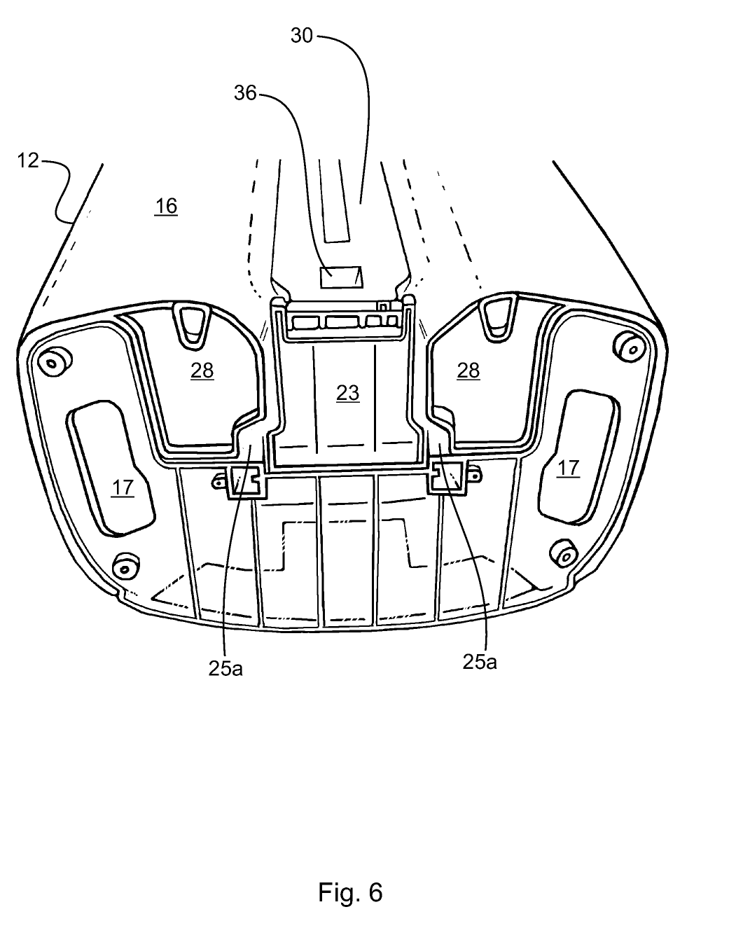

FIG. 6 is a bottom view of can 10. Pedal lever 23 is operatively attached to the outer surface of center portion 17a (not seen in FIG. 6) by screws 27. Pegs 25 extend into slots 25a to provide rotatable support for pedal lever 23. By rotatable support is meant that slots 25a are shaped to both hold pedal lever 23 in position and to allow pedal lever 23 to move through an arc similar to a see-saw when pedal 20 is depressed and released.

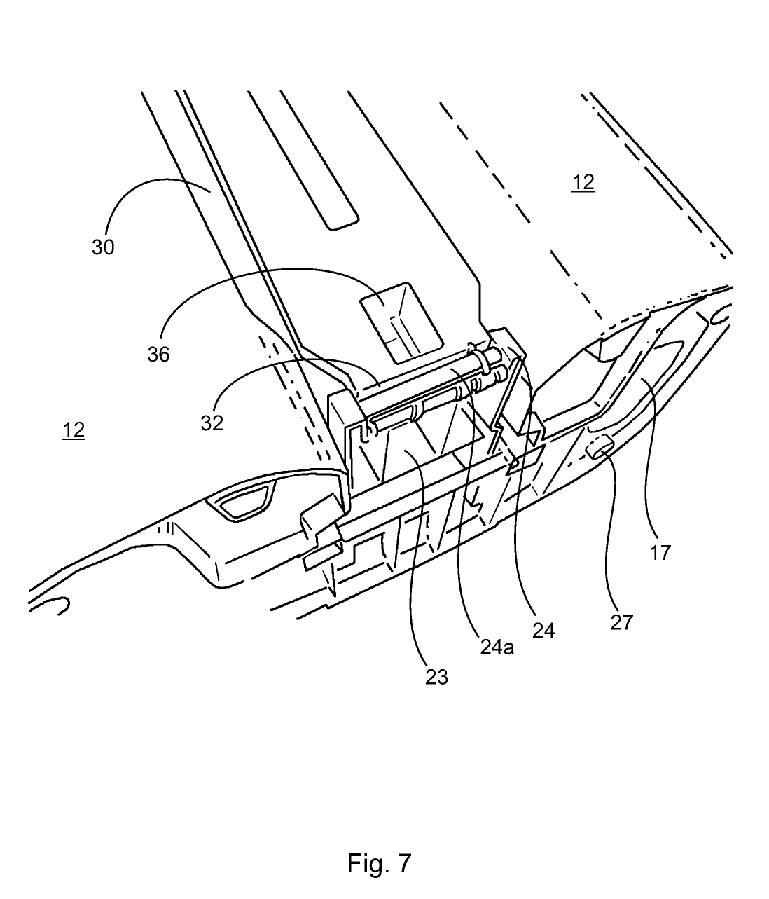

FIG. 7 is an enlarged view of the connection between first riser end 32 and movement end 24 of pedal lever 23. In the embodiment shown, first riser end 32 is curved and receives pin bar 24a that extends across movement end 24. This configuration enables pedal lever 23 to lift first riser end 32 when movement end 24 is elevated by pedal 20.

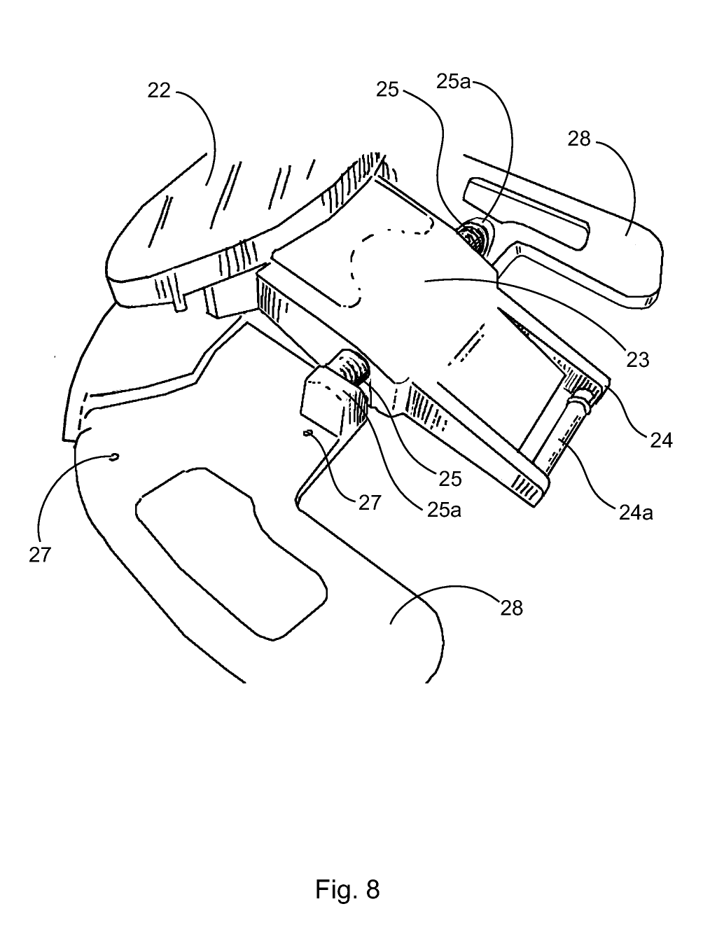

FIG. 8 is an enlarged view of pedal assembly 20. Pedal assembly base 28 (“assembly base 28”) supports pedal assembly 20. Pedal 22 is attached to pedal lever 23 which is terminates with movement end 24. In one embodiment, pedal 22 and movement end 24 are fabricated as one integral structure. By integral is meant that the component parts are formed together as a single unit. Clearly seen is bar 24a which extends between the two ends of movement end 24. Pegs 25 fit into slots 25a which are integral to assembly base 28 to both support pedal lever 23 and allow it to pivot about slots 25a to raise and lower movement end 24 which raises and lowers attached riser 30. Screw holes 27 in assembly base 28 allow the attachment of pedal assembly 20 to bottom surface 17 with pedal lever 23 under center portion 17a. In one embodiment, pedal base 28 is a fabricated as an integral structure to include slots 25a.

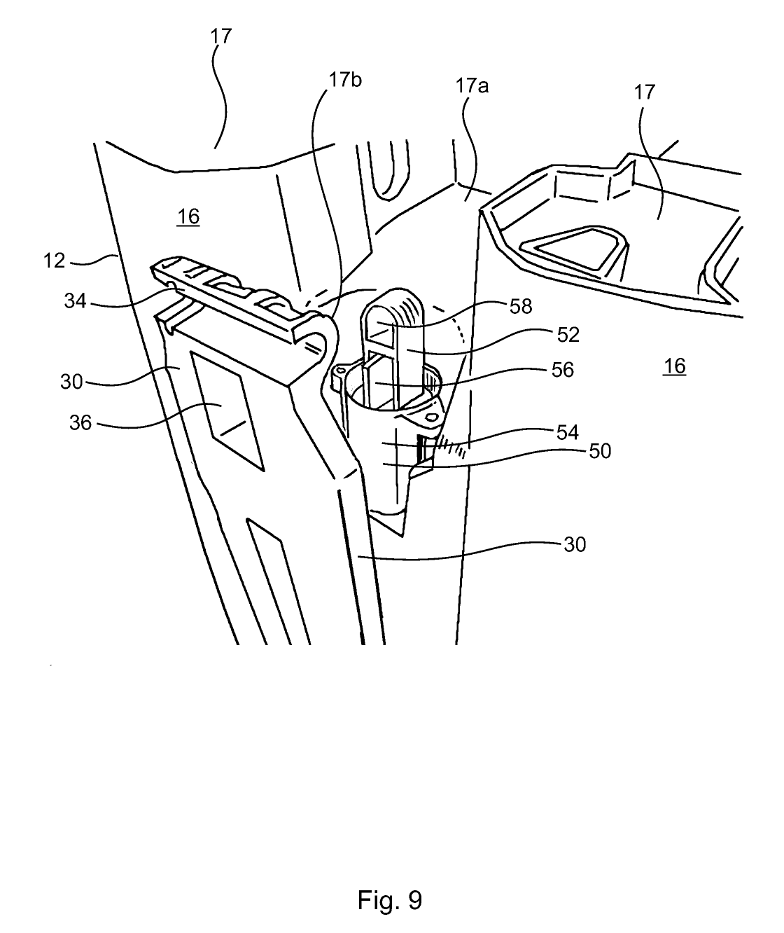

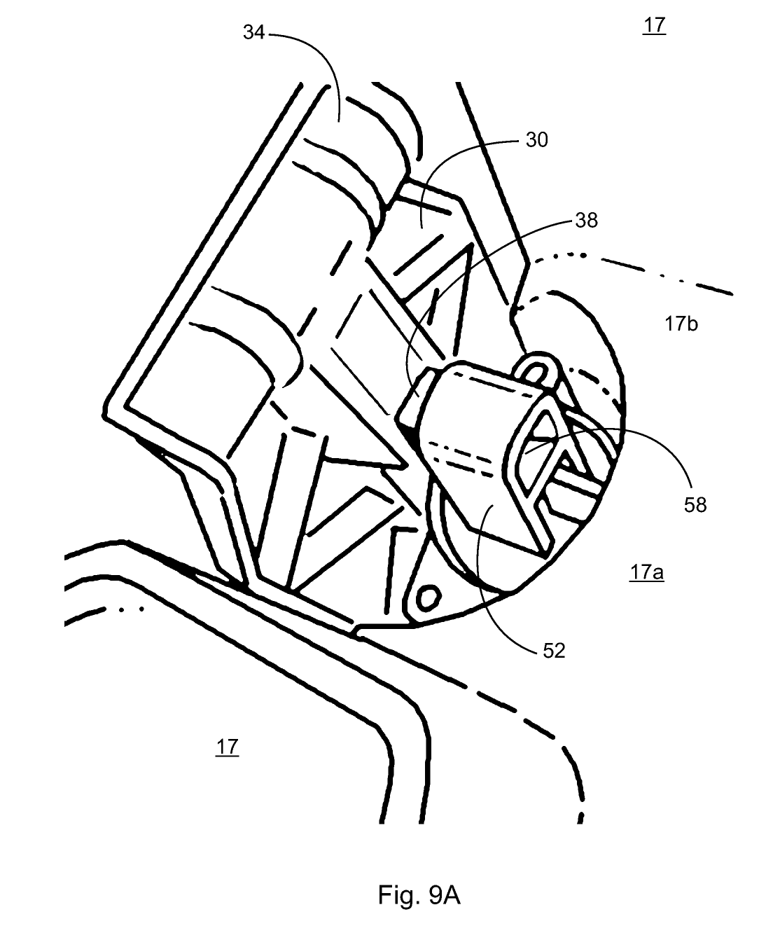

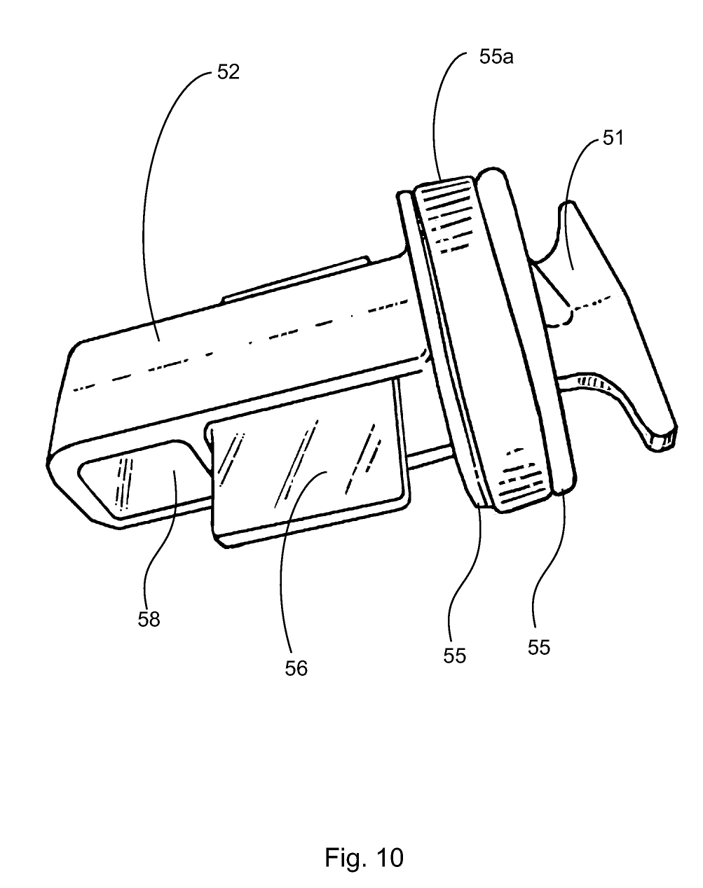

FIG. 9 is an enlarged bottom view of garbage can 10 showing damper 50 fixedly attached to well 17b located at the back end of center portion 17a. Damper 50 includes chamber 54 placed within well 17b and piston 52 which is sized to be placed within chamber 54. Guide fins 56 extend from piston 54 and act to keep piston 54 in alignment when it moves within chamber 54. Above fins 56 is aperture 58. FIG. 9A shows riser 30 operatively attached to piston 52 by the fitting of projection 38 from riser 30 into aperture 58. By operatively attached is meant that a component or device is connected either directly or indirectly to a second component and causes that second component to function. For example, as described above, riser 30 is described as operatively attached or operationally attached to piston 52 meaning riser 30 causes the piston 52 to raise and lower. Preferably, this fitting is a friction fit.

FIG. 10 is a perspective view of piston 52. Stop 51 prevents piston 52 from traveling too far down into chamber 54. Seal complex 55 with seal 55a fits loosely into chamber 54 and provides friction to its movement. Seal 55a may be fabricated from rubber or other suitable materials known to those having skill in the art.

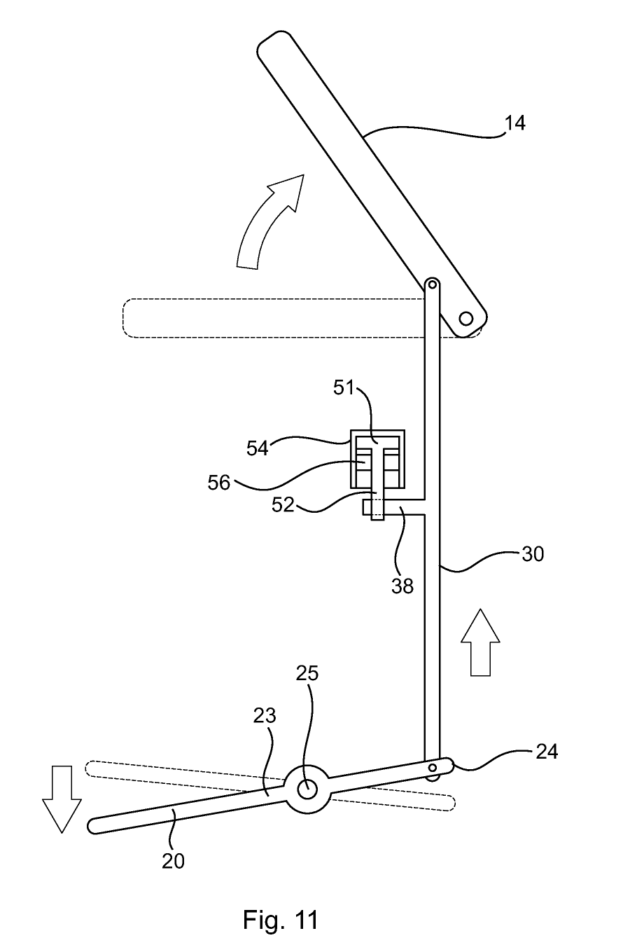

FIGS. 11 and 11A are schematic figures demonstrating the action of the damper 50 on the riser 30. In FIG. 11, pressing on pedal 22 causes pedal lever 23 to lift riser 30 and piston 52 is pushed into chamber 54. As seen in FIG. 11A, when riser 30 falls, piston 52 is pulled out of chamber 54. Fins 56 contact preferably loosely the sides of chamber 45 to keep piston 52 aligned and prevent jamming.

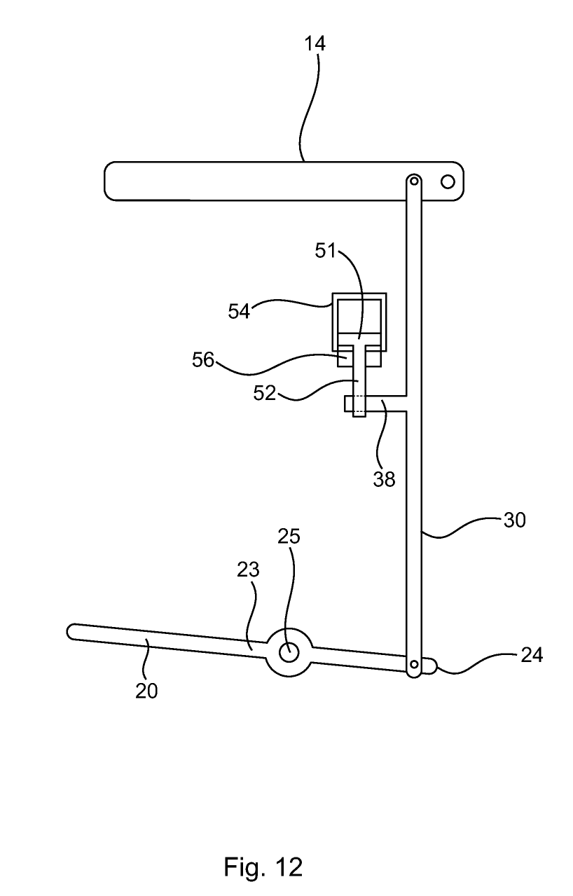

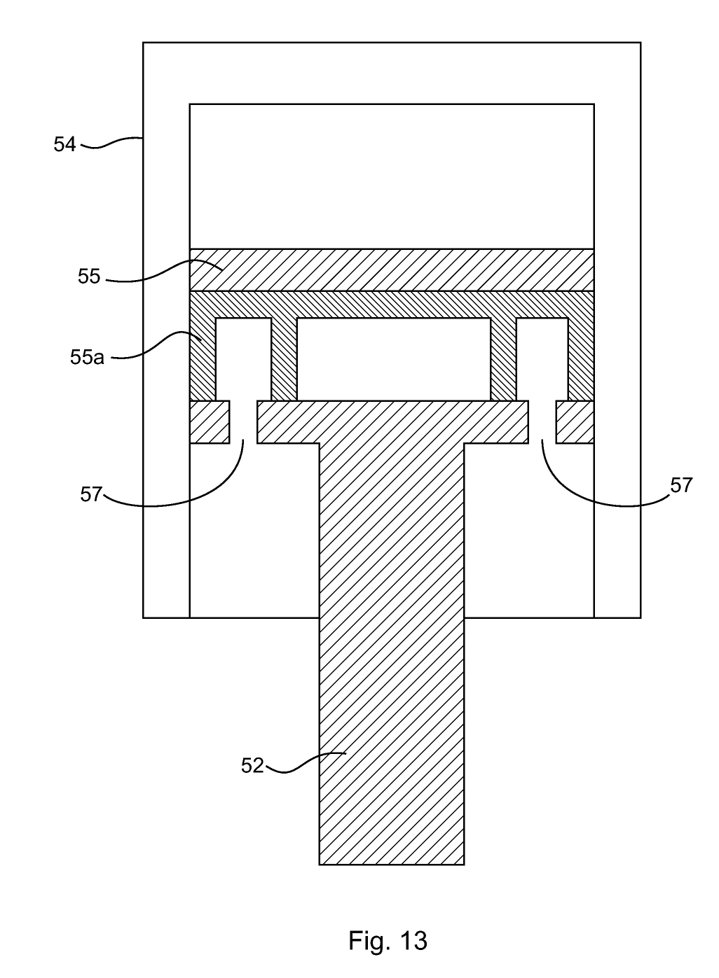

FIG. 12 is a schematic demonstration as to how damper 50 slows the fall of piston and attached riser 30 when pedal lever 23 falls. During riser elevation, piston 52 is pushed easily into chamber 54 due to the loose fit of piston 52 within chamber 54. When pedal 22 is released, riser 30 starts to fall and pull piston 52 out of chamber 54. This pulling action is resisted by the air forced into air ports 57 in seal complex 55. The air expands seal 55a against the walls of chamber 54 thereby resisting the fall of riser 30.

Thus it is seen that the objects of the invention are efficiently obtained, although changes and modifications to the invention should be readily apparent to those having ordinary skill in the art, which changes would not depart from the spirit and scope of the invention as claimed.

1. A garbage can comprising:
a can portion having a bottom wall, at least one tubular wall extending upwardly from the bottom wall and including an upper rim, an inner chamber defined by the bottom wall and the tubular wall, and an open top;
a lid;
a bag ring having a recessed under surface adapted to receive the upper rim therein, the ring being pivotally coupled to the lid and arranged to pivot onto and off of the upper rim;
a pedal assembly, the pedal assembly including a pedal lever operatively attached to said bottom wall and having a first end and a second end, said first end including a pedal;
a riser having a first end and a movement end, wherein the movement end of the riser is pivotably connected to the second end of said pedal lever and the first riser end is pivotably connected to the lid; and,
a damper fixedly attached to said outer surface of said bottom wall and operatively attached to said riser;
wherein the pedal lever is arranged to lever the riser upwardly when said step pedal is depressed, and the riser is arranged to pivot the lid off of the ring when levered upwardly by the step pedal.

2. The garbage can as recited in claim 1 wherein said damper comprises a chamber and a piston placed inside said chamber.

3. The garbage can as recited in claim 2 wherein said damper chamber is fixedly attached in a well formed in said bottom surface.

4. The garbage can as recited in claim 2 wherein said riser includes a projection and said piston defines an aperture wherein said projection is inserted into said aperture to form said operative attachment.

5. The garbage can as recited in claim 2 wherein said riser pushes said piston into said chamber when said pedal is depressed.

6. The garbage can as recited in claim 2 wherein said riser pulls said piston from said chamber when said pedal is released.

7. The garbage can as recited in claim 2 wherein said riser pushes said piston into said chamber when said pedal is depressed and said riser pulls said piston from said chamber when said pedal is released;
wherein said pulling movement is slower than said pushing movement.

8. The garbage can as recited in claim 2 wherein said piston further comprises at least one guide fin.

9. The garbage can as recited in claim 2 wherein said piston further comprises a stop.

10. The garbage can as recited in claim 2 wherein said piston further comprises a seal complex, said seal complex including a soft rubber seal between two outer layers.

11. The garbage can as recited in claim 10 wherein at least one of said outer layers and said rubber seal each includes at least one air port wherein each of said outer layer air ports is aligned with a rubber seal air port.

12. The garbage can as recited in claim 1 wherein said bottom wall includes a center raised portion and said pedal assembly fits at least partly within said center raised portion.
